(19) United States
(12) Patent Application Publication
(10) Pub. No.: US 2014/0306057 A1
(43) Pub. Date: Oct. 16, 2014

(54) SYSTEMS AND METHODS FOR USING A HYBRID STYLE AIRSHIP

(71) Applicant: CGG SERVICES SA, Massy Cedex (FR)

(72) Inventors: Laurent CASSE, Massy (FR); Eelco SIXMA, Massy (FR)

(73) Assignee: CGG SERVICES SA, Massy Cedex (FR)

(21) Appl. No.: 14/191,676

(22) Filed: Feb. 27, 2014

Related U.S. Application Data
(60) Provisional application No. 61/810,389, filed on Apr. 10, 2013.

(51) Int. Cl. G01V 1/22; B64B 1/52; B64B 1/62

(52) U.S. Cl. CPC G01V 1/22; B64B 1/62; B64B 1/52
USPC 244/33; 244/99

(57) ABSTRACT

Systems and methods are provided for a communication system configured to be used in land geophysical operations. The system includes: a balloon configured to lift one or more antennas; at least one cable connected to the balloon and configured for transmission of at least one of power and data, configured as a tether connected to the balloon and configured to be deployed such that an altitude of the balloon is between 50 and 100 meters; one or more antennas mounted internally or externally to the balloon and configured to extend a communication range between a base station, a command and control truck, and one or more seismic shooting devices for communicating information associated with seismic acquisition activities; and an electronics suite configured to trigger a controlled descent of the balloon and configured to deflate the balloon.

### RELATED APPLICATIONS

The present application claims priority under 35 U.S.C. §119(e) to U.S. Provisional Patent Application Ser. No. 61/810,389, filed Apr. 10, 2013, for “Antenna Masts and Towers Alternative with Tethered Balloon” the entire contents of which are expressly incorporated herein by reference.

### TECHNICAL FIELD

The embodiments relate generally to supporting activities associated with the oil and gas industry and, more particularly, to supporting communications for such.

### BACKGROUND

A widely used technique for searching for hydrocarbons, e.g., oil and/or gas, is the seismic exploration of subsurface geophysical structures. Reflection seismology is a method of geophysical exploration to determine the properties of a portion of a subsurface layer in the earth, which information is especially helpful in the oil and gas industry. Marine-based seismic data acquisition and processing techniques are used to generate a profile (image) of a geophysical structure (subsurface) of the strata underlying the seafloor. This profile does not necessarily provide an accurate location for oil and gas reservoirs, but it may suggest, to those trained in the field, the presence or absence of oil and/or gas reservoirs. Thus, providing an improved image of the subsurface in a shorter period of time is an ongoing process.

The seismic exploration process includes generating seismic waves (i.e., sound waves) directed toward the subsurface area, gathering data on reflections of the generated seismic waves at interfaces between layers of the subsurface, and analyzing the data to generate a profile (image) of the geophysical structure, i.e., the layers of the investigated subsurface. This type of seismic exploration can be used both on the subsurface of land areas and for exploring the subsurface of the ocean floor.

One challenge involved with operations associated with both seismic exploration and the operations of producing hydrocarbon fields is communications. More particularly, being able to have communications coverage over the large distances and remote locations in which oilfield operations are often conducted can be difficult, costly or not completely possible.

Communications are extensively used in land and marine seismic acquisition operations. Examples of common, but important communications include the following: (1) voice communications to operationally direct crews and for emergency communications/coverage; (2) vibrator sweep synchronization and shooting commands; (3) helicopter navigation and tracking; (4) vehicle and small boat tracking to include journey management; and (5) inter-vessel transmission of navigation data and shooting synchronization.

Many of these communications occur using very high frequency (VHF) and ultra high frequency (UHF) communications. The communication range of VHF/UHF systems is a function of equipment output power, atmospheric conditions and antenna height. Equipment output power is often around 25 Watts (maximum) and often controlled by radio frequency guidelines of the location where they are being operated. Atmospheric conditions are often not a major factor for VHF/UFH systems, however, antenna height can be a large factor in determining communication distance. Examples of line of sight (LOS) distances for VHF/UHF systems with two antennas (transmitting and receiving) are shown below with respect to Table (1).

| Antenna | 0 m | 1.5 m | 10 m | 15 m |
|---|---|---|---|---|
| Heights | (receiving) | (receiving) | (receiving) | (receiving) |
| 10 m (transmitting) | 13 km | 18 km | 26 km | 29 km |
| 15 m (transmitting) | 16 km | 21 km | 29 km | 32 km |
| 30 m (transmitting) | 23 km | 28 km | 36 km | 39 km |
| 50 m (transmitting) | 29 km | 34 km | 42 km | 45 km |
| 100 m (transmitting) | 41 km | 46 km | 54 km | 57 km |

So it can be seen from Table (1) that the transmission distance between a transmitting antenna at a height of 30 m and a receiving antenna with a height of 1.5 m (which could be a person with a hand held device) would be a theoretical maximum of 28 kilometers.

Antennas are typically mounted on higher parts of vessels or buildings when possible. Additionally, fixed or so-called “Texas towers” or telescoping antenna systems (either hydraulic or cable winch operated) are also used in some cases when mounting an antenna on a building is not practical. For camps, radio rooms and other staging areas used in land operations, hydraulic telescoping antennas have been used with a height of about ten meters. In North America, trailer mounted telescoping Texas towers of thirty meters in height are in use. To support communications coverage of many locations, such as remote camps, repeater stations are often deployed. An additional concern when setting up such towers or mounting antennas is that such operations have inherent operational safety issues, for example, having people aloft at such heights, which are not desirable.

Regarding marine operations, communications can be challenging and/or not always possible using conventional methods as the distance between Wide Azimuth (WAZ) fleet vessels makes inter-vessel communications problematic. Additionally, as it may be desirable for larger inter-vessel distances to be used, expensive downtime associated with lost communications can occur as certain communications are necessary for certain operations, e.g., sharing of navigational data and shooting synchronization.

Another challenge involves helicopters as helicopters can be used in both marine and land seismic operations. More specifically, tracking and voice communication is often not possible with a helicopter on the ground as the helicopter's antenna is positioned in the belly of the helicopter rendering an antenna height close to zero meters.

Other general issues with communications can include the need for frequent relocation and movement, limited transmission/reception ranges and limitations on vehicle access based on terrain. Additionally, in rough terrain, shadow zones can impede communication. In jungle areas such as Gabon and Peru, trained individuals are needed to raise antennas on high trees as standard telescopic antennas do not get above the tree canopy. This provides a very limited transmission range, e.g., 5-7 km, as well as being dangerous to the individual(s) attaching the antennas to the trees.

Accordingly, it would be desirable to provide methods and systems that avoid the afore-described problems and drawbacks.

### SUMMARY

According to an embodiment, there is a communication system configured to be used in land geophysical operations, the system comprising: a balloon configured to lift one or more antennas, wherein the balloon includes a tail section for keeping a front of the balloon aligned in a desired direction; at least one cable connected to the balloon and configured for transmission of at least one of power and data, configured as a tether connected to the balloon and configured to be deployed such that an altitude of the balloon is between 50 and 100 meters, wherein a first end of the cable is connected to the balloon and a second end of the cable is connected to an object in contact with the ground; one or more antennas mounted internally or externally to the balloon and configured to extend a communication range between a base station, a command and control truck, and one or more seismic shooting devices for communicating information associated with seismic acquisition activities; a cable drum configured to both deploy and reel in the cable; and an electronics suite configured to trigger a controlled descent of the balloon and configured to deflate the balloon.

According to an embodiment, there is a communication system configured to be used in marine seismic acquisition operations, the system comprising: a balloon configured to lift one or more antennae, wherein the balloon includes a tail section for keeping a front of the balloon aligned in a desired direction; at least one cable connected to the balloon and configured for transmission of at least one of power and data, configured as a tether connected to the balloon and configured to be deployed such that an altitude of the balloon is between 50 and 100 meters, wherein a first end of the cable is connected to the balloon and a second end of the cable is connected to a vessel for use in marine seismic data acquisition activities; one or more antennas mounted internally or externally to the balloon and configured to extend a communication range between wide azimuth fleet vessels for communicating information associated with seismic acquisition activities; a cable drum configured to both deploy and reel in the cable; and an electronics suite configured to trigger a controlled descent of the balloon and configured to deflate the balloon.

According to an embodiment, there is a system for deploying a balloon associated with a communication system configured to be usable in both land and marine seismic acquisition operations, the system comprising: a means for controlling an ascent of the balloon such that the balloon stops ascending at a height between 50-100 meters above an anchor point; a means for anchoring a cable attached to the balloon to the anchor point; a means for communicating information associated with at least one of land and marine seismic acquisition activities, wherein the information is associated with at least one of seismic shooting synchronization and seismic recording information; a means for extending a range for communicating information associated with both land and marine seismic activities; and a means for triggering a controlled descent of the balloon.

### BRIEF DESCRIPTION OF THE DRAWINGS

The accompanying drawings illustrate exemplary embodiments, wherein:

FIG. 1(a) depicts a tethered balloon (T-Boon) system according to an embodiment;

FIG. 1(b) shows an interior portion of a balloon with an antenna according to an embodiment;

FIG. 2 shows additional elements of a T-Boon system according to an embodiment;

FIG. 3 illustrates a land seismic acquisition system according to an embodiment;

FIG. 4 shows a marine seismic acquisition system according to an embodiment;

FIG. 5 illustrates a flowchart of a method for performing communications in land seismic operations according to an embodiment; and

FIG. 6 shows a flowchart of a method for performing communications in marine seismic operations according to an embodiment.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

According to embodiments, and in order to address, among other things, the problems discussed in the Background, communication systems which incorporate balloons with antennas for extending communication ranges are described below for use in support of oilfield communications as well as land and marine seismic activities. For example, according to an embodiment, by having a transmitting antenna at a higher altitude, shadow zones can be reduced in size and frequency and from a safety point of view using balloons can reduce/eliminate having people working at potentially dangerous heights when installing/mounting antennas.

According to an embodiment, a tethered balloon, also known as a “T-Boon”, can be manufactured and deployed to achieve higher antenna positions, e.g., 50-100 meters above the ground or surface to which the T-Boon is tethered. The balloon's lifting capacity can be designed such that the balloon can lift one or more antennas to a desired altitude. This altitude can be maintained by the design of the balloon with, as desired, a controlling tether which can be one or more cables, i.e., the length of the tether (or the amount of tether released) can control the final altitude of the balloon.

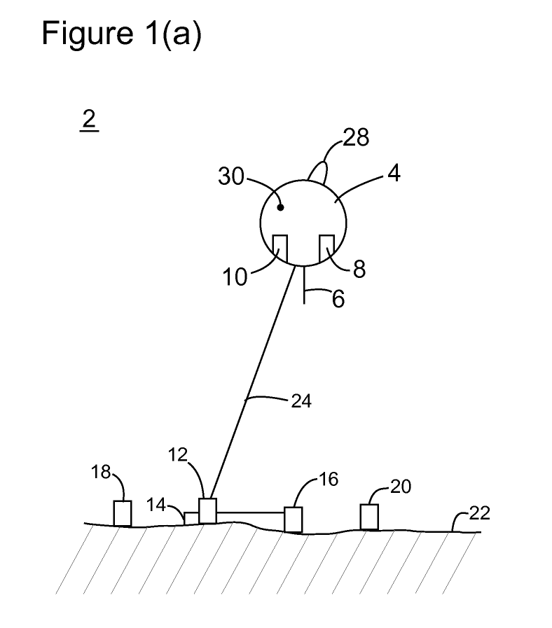

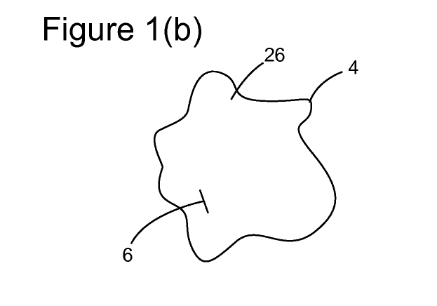

According to an embodiment, a T-Boon system 2 which can act as a communication system, or a portion of a communication system, as shown in FIG. 1(a) can include a balloon 4, one or more antennas 6, at least one cable 24 which can act as the tether and which can also include one or more power and data transmission cables, a balloon controlling electronics suite 8 and optionally one or more radio power amplifiers 10. The at least one cable 24 can, for example, include a power cable, a transmission cable and a separate tether. Alternatively, the at least one cable 24 can be a single cable configured to perform all three functions describes, a combined power and data cable with two separate tether cables, or some variation thereof as desired. The balloon controlling electronics suite 8 as well as the one or more radio power amplifiers 10 can attached to and be located inside of or below the balloon 4. The antennas 6 can be mounted externally as shown in FIG. 1(a), mounted on an interior portion 26 of the balloon 4 as shown in FIG. 1(b), or some combination of both as desired. The balloon 4 can include a tail section 28 which can be configured to allow the balloon 4 to point generally into the wind or to keep the balloon 4 aligned in a desired direction. Additionally, a safety valve 30 can be included as a portion of the balloon 4 to allow for deflation.

According to an embodiment, the T-Boon system 2 can also include various support equipment including a cable drum 12 which can include an anchoring mechanism 14 (with cable drum 12 and/or anchoring mechanism 14 acting as an anchoring point) for secure attachment to the ground 22 (or to a ship for marine embodiments), a generator 16, ground radio electronics 18 and a gas storage device 20, e.g., a bottle, for inflating the balloon 4. The generator 16 can be a relatively small generator, e.g., a 2-5 kVA generator. The gas used in the gas storage device 20 can be helium, hydrogen, methane or any other lighter than air gas as desired.

According to an embodiment, for use in land environments the T-Boon system 2 can be mounted on a pickup truck or in a heli-portable cage. This size of a system, e.g., 5 meters or less in length, allows for deployment in a large variety of land terrains in which communications for seismic exploration and/or exploitation can occur. For marine use, the T-Boon system 2 can be located near a helideck of a ship where the T-Boon system 2 can be configured for deployment and recovery from the helideck of the ship. Additionally, according to an embodiment, while not shown in FIG. 1, the balloon 4 could also include some form of a propulsion unit to further counteract wind forces or be used to assist in aligning the front of the balloon 4 as desired. In one embodiment, the propulsion unit can be a part of the tail section 28 and include battery backup as well as one or more propellers. This propulsion unit may be more desirable in marine use to counter ship-driven wind effects on the balloon 4.

According to an embodiment, the balloon controlling electronics suite 8 can be configured to control the optional propulsion unit for maintaining the balloon 4's position vertically (or as near to as possible or desired) over the deployment location. The balloon controlling electronics suite 8 can also trigger a controlled descent of the balloon 4 when desired, e.g., in case of system break downs, when wind speeds exceed a preset threshold, or when a predetermined electrical gradient is reached due to an imminent thunderstorm. Other reasons that a controlled, automatic descent of the balloon 4 may be desired may include: a fast drop of atmospheric pressure, a horizontal position of the balloon 4 shifting more than a defined distance from the vertical above the balloon 4's tether point, breakdowns or warnings of a breakdown for controlling equipment, the lifting capacity of the balloon 4 dropping below a predefined threshold, excessive heat developed in one of the lifted systems and in a marine embodiment the descent could also be triggered based on a scheduled arrival of a helicopter. According to an embodiment the balloon controlling electronics suite 8 can be configured to start the cable drum 12 to winch down the cable 24 and attached balloon 4. For this case, a slip ring, which is a device which allows for rotation while maintaining continuous electrical contact, may be used. The slip ring may be used at the bottom of the cable 24, however, according to an embodiment another slip ring could also be used near (or at) the top of the cable 24 near where the cable 24 would attach to the balloon 4.

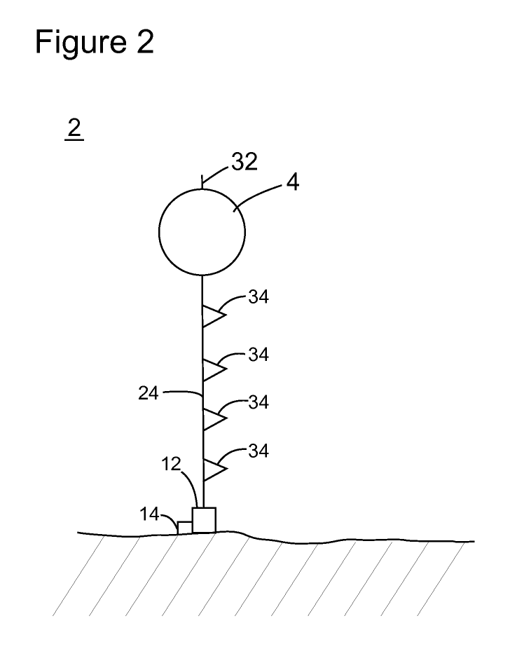

According to an embodiment, the balloon controlling electronics suite 8 can deflate the balloon 4 in case of cable 24 breakage or in other desired circumstances. Deflation using the safety valve 30 can be an active effort, i.e., power is used to keep the safety valve 30 closed, and as such when the balloon controlling electronics suite 8 turns off power to the safety valve 30 the safety valve 30 opens, deflating the balloon 4. According to an embodiment, a red flashing light can be added the T-Boon system 2 on, for example, the top of the balloon 4 for enhancing visibility. Additionally, brightly colored flags can be attached at various positions along the cable 24 to also enhance visibility. A simplified T-Boon system 2 is shown in FIG. 2 to show examples of the red flashing light 32 and the colored flags 34.

According to an embodiment, the balloon controlling electronics suite 8 can also be used to maintain or modify, possibly in conjunction with the amount of cable 24 used, the altitude of balloon 4. For example, the controlling electronics suite 8 can open the safety valve 30 to release some of the stored gas until the balloon 4 descends to a new desired altitude at which time the controlling electronics suite 8 can close the safety valve 30 to maintain the new desired altitude. Commands for such an operation can be sent remotely to the balloon controlling electronics suite 8, alternatively, the electronics controlling suite 8 can be preprogrammed to automatically perform this operation based on detected environmental conditions meeting a preset condition, e.g., pressure changes, wind speeds or other desired parameters. The cable 24 can then be reeled in as desired by, for example, the cable drum 12.

Embodiments described herein can allow for an increased range in communications as compared to conventional communications used in support of various oil field related communications. For example, in some conventional applications, the height of an antenna may be at 10 meters or 30 meters. The associated communication ranges for these antenna heights are 13 kilometers (km) and 23 km, respectively (for a receiver on or near the ground). According to an embodiment, the T-Boon system 2 can allow for one or more antenna to be at a height of 50 meters to 100 meters which allows for communication ranges of 29 km and 41 km, respectively. This allows for an increase in the covered surface area by 2.7 times when comparing the 30 meter height antenna to the 100 meter height antenna.

According to embodiments, the one or more antennas 6 can be in the form of externally mounted on the balloon 4 rigid “T” shaped frames, e.g., as currently used on Texas towers, or flexible antennas which are taped or otherwise attached to the cable 24 or to other cables which could be attached to the balloon 4. According to an embodiment, antennas 6 can be directional antennas and/or antennas which are mounted to the balloon 4 or cable 6 such that the antennas 6 can either orient themselves or be oriented via received commands at the controlling electronics suite 8. According to another embodiment, the antennas 6 can be mounted inside the balloon 4 while still having the ability to be directional and orientable as desired. Internally mounted antennas 6 can allow for a reduction in wind resistance, can reduce the difficulty in retrieving the balloon 4 and can reduce a chance of tangling between antennas 6 and the cable 24 as well as any other possible entanglements. According to another embodiment, a combination of internally and externally mounted antennas 6 can be used.

According to embodiments, using the T-Boon system 2 can allow for various improvements associated with industrial applicability features in such things as efficiency, safety and overall communications. For example, use of the T-Boon system 2 can allow for fewer moves of Labo truck (a command and control style truck) positions and/or communication repeater stations as well as creating fewer/smaller shadow zones, by having the transmitting antennas 6 being at a relatively higher altitude from a conventional antenna, which can reduce associated downtime. With shadow zones being a zone in which communications cannot be received or are limited in their ability to be received as a terrain feature blocks the line of sight for the VHF/UHF transmission to be received. From a safety point of view, the use of the T-Boon system 2 can also reduce/eliminate working at dangerous heights, e.g., mounting of the rigid Texas towers or on building rooftops where conventional antennas are often located.

According to an embodiment, for marine use, the T-Boon system 2 can allow for reduced downtime in Wide Azimuth (WAZ) fleet operations as well as potentially being used for data transmission to shore when an antenna of an acceptable height is available for reception on shore. Additionally, when used in support of tracking platforms, the T-Boon system 2 can allow for an increased range of helicopter, small craft or vehicle tracking in both land and marine applications as desired. While WAZ fleet operations are used herein as an example of how the T-Boon system 2 can be used in support of marine seismic operations, the T-Boon system 2 can also be used in support of other marine operations, such as, towed streamer operations.

According to an embodiment, the T-Boon system 2 can be used in support of various types of communications. These communications in support of land seismic acquisition activities can include the following: (1) coordinating communications for vibrator sweep synchronization and shooting commands; (2) general radio communications; (3) the rebroadcast of various radio communications; and (4) coordinating communications for commencing and terminating seismic recording activities. These communications in support of marine seismic acquisition activities can include the following: (1) communications between wide azimuth fleet vessels and a shore facility; (2) communications associated with navigation data and/or shooting synchronization for the WAZ fleet vessels; and (3) received seismic signals from a marine seismic streamer (which in this case includes various data modules, e.g., a hydrophone). The navigation data can include absolute position information and/or relative position information for wide azimuth fleet vessels from a control vessel.

While the phrase land seismic activities has been used herein while describing various embodiments, embodiments described herein associated with the T-Boon system 2 can also be used in support of other land geophysical operations or activities to include, but not be limited to, electromagnetic (EM) and/or gravity-magnetic (Gravmag) seismic activities as well as any other types of operations which can benefit from the embodiments described herein. Similar comments also apply to marine embodiments.

According to an embodiment, the T-Boon system 2 can be configured to be deployed in a variety of terrains, e.g., relatively remote and/or typically inaccessible terrain, by, for example, keeping the size of the T-Boon system's footprint appropriate for the deployment location. The T-Boon system 2 can be delivered via, for example, a pickup truck or a helicopter to the desired operating location.

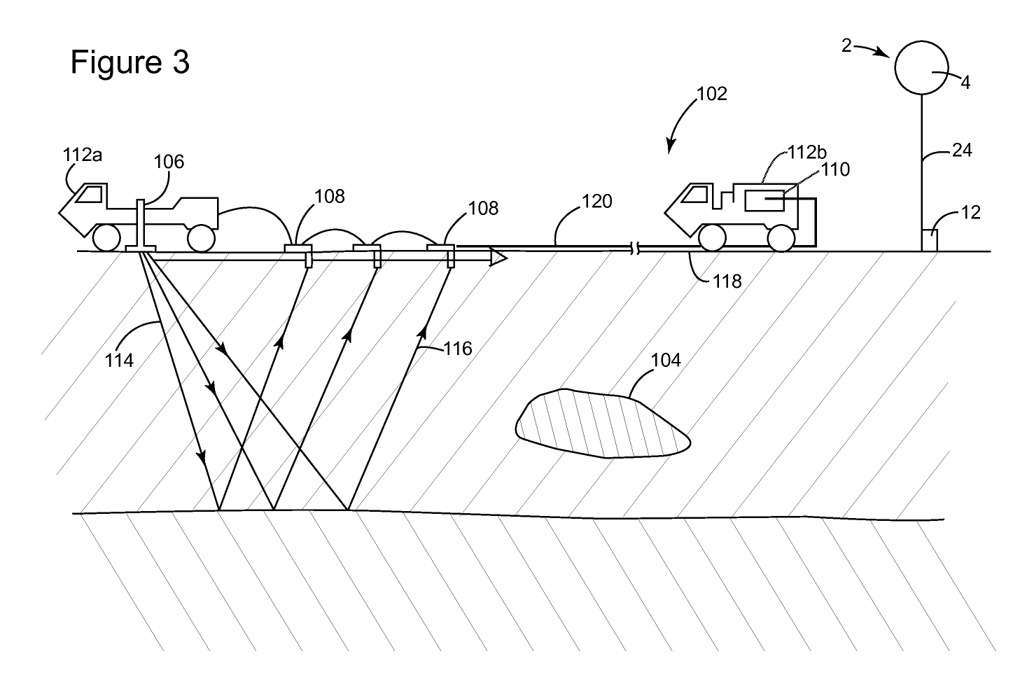

Embodiments described herein associated with the T-Boon system 2 can be used in support of land (to include EM and Gravmag seismic systems) or marine seismic exploration systems (to include WAZ fleet systems) for transmitting and receiving seismic waves intended for seismic exploration. An example of such a land system is shown in FIG. 3. FIG. 3 depicts a land seismic exploration system 102 for transmitting and receiving seismic waves intended for seismic exploration in a land environment. At least one purpose of system 102 is to determine the absence, or presence of hydrocarbon deposits 104, or at least the probability of the absence or presence of hydrocarbon deposits 104. System 102 includes a source 106 operable to generate a seismic signal (transmitted waves 114), a plurality of receivers 108 (e.g., geophones) for receiving seismic signals 116 and converting them into electrical signals, and seismic data acquisition system 110 (that can be located in, for example, vehicle/truck 112 (a and/or b)) for recording the electrical signals generated by receivers 108. Source 106, receivers 108, and data acquisition system 110 can be positioned on the surface of ground 118, all of which can be interconnected by one or more cables 120. FIG. 3 further depicts a single source 106, but it should be understood that source 106 can be composed of multiple or a plurality of sources 106, as is well known to persons skilled in the art. Additionally, FIG. 3 shows a simplified T-Boon system 2 to include the balloon 4, cable drum 12 and the cable 24, but it is to be understood that the entire T-Boon system 2 can be used in land operations.

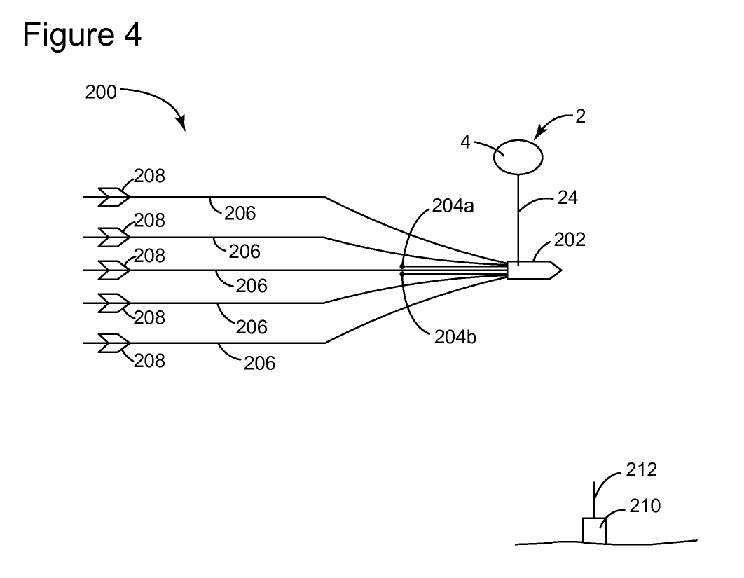

An example of a system and an environment for acquiring marine seismic data in which a T-Boon system 2 can be used will now be described with respect to FIG. 4. For a seismic gathering process, as shown in FIG. 4, a data acquisition system 200 includes a ship 202 towing plural streamers 206 that may extend over kilometers behind ship 202. Each of the streamers 206 can include one or more birds 208 that maintains streamer 206 in a known fixed position relative to other streamers 206, and the birds 208 are capable of moving streamer 206 as desired according to bi-directional communications the birds 208 can receive from ship 202. One or more source arrays 204 a,b may also be towed by ship 202 or another ship for generating seismic waves. Source arrays 204 a,b can be placed either in front of or behind receivers, or both behind and in front of receivers. The seismic waves generated by source arrays 204 a,b propagate downward, reflect off of, and penetrate the seafloor, wherein the refracted waves eventually are reflected by one or more reflecting structures (not shown in FIG. 4) back to the surface. The reflected seismic waves propagate upwardly and are detected by receivers 210 provided on streamers 206. Additionally, FIG. 4 shows a simplified T-Boon system 2 to include the balloon 4 and the cable 24, but it is to be understood that the entire T-Boon system 2 can be used in marine operations. Also, a shore facility 210 with an antenna 212 which can receive information and/or communicate with the ship 202 is shown.

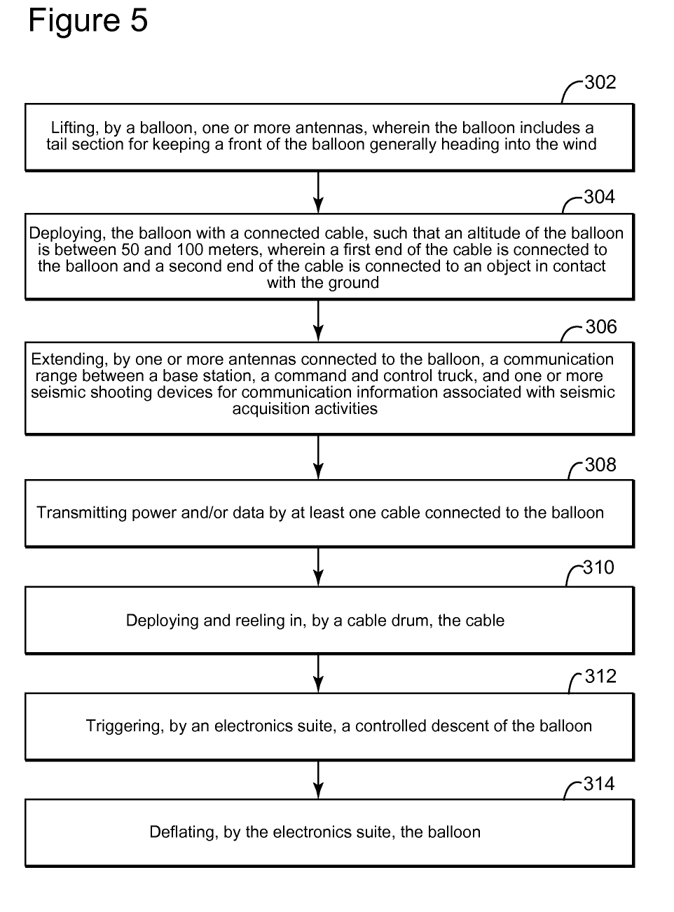

Utilizing the above-described systems according to an embodiment, there is a method for performing communications in land geophysical operations as shown in FIG. 5. The method includes: at step 302, lifting, by a balloon, one or more antennas, wherein the balloon includes a tail section for keeping a front of the balloon generally heading into the wind; at step 304, deploying, the balloon with a connected cable, such that an altitude of the balloon is between 50 and 100 meters, wherein a first end of the cable is connected to the balloon and a second end of the cable is connected to an object in contact with the ground; at step 306, extending, by one or more antennas connected to the balloon, a communication range between a base station, a command and control truck, and one or more seismic shooting devices for communicating information associated with seismic acquisition activities; at step 308, transmitting power and/or data by at least one cable connected to the balloon; at step 310, deploying and reeling in, by a cable drum, the cable; at step 312, triggering, by an electronics suite, a controlled descent of the balloon; and at step 314, deflating, by the electronics suite, the balloon.

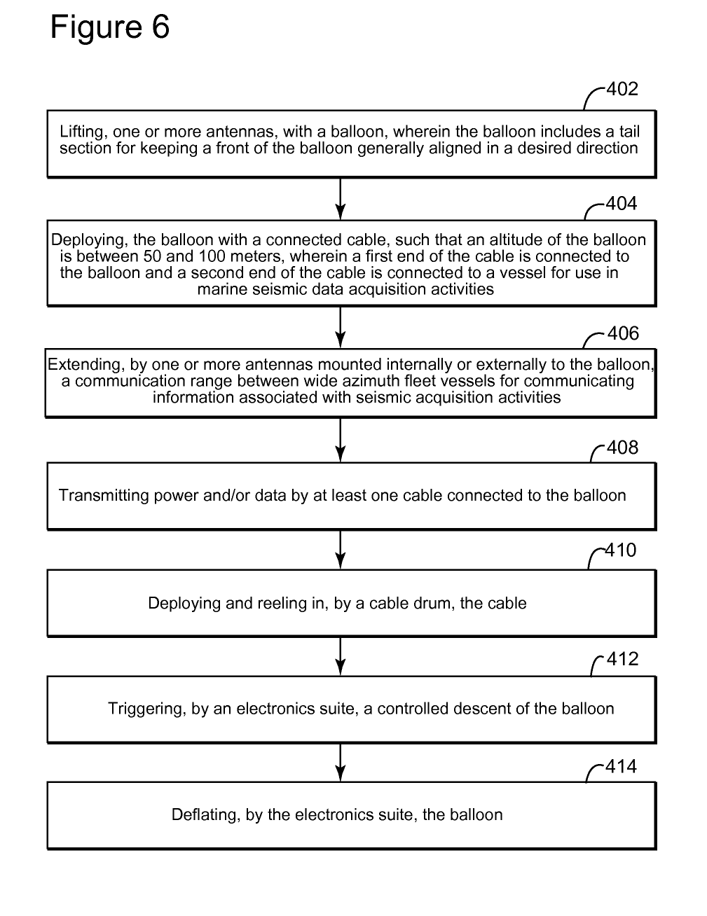

Utilizing the above-described systems according to an embodiment, there is a method for performing communications in marine seismic operations as shown in FIG. 6. The method includes: at step 402, lifting, one or more antennas, with a balloon, wherein the balloon includes a tail section for keeping a front of the balloon aligned in a desired direction; at step 404, deploying, the balloon with a connected cable, such that an altitude of the balloon is between 50 and 100 meters, wherein a first end of the cable is connected to the balloon and a second end of the cable is connected to a vessel for use in marine seismic data acquisition activities; at step 406, extending, by one or more antennas mounted internally or externally to the balloon, a communication range between wide azimuth fleet vessels for communicating information associated with seismic acquisition activities; at step 408, transmitting power and/or data by at least one cable connected to the balloon; at step 410, deploying and reeling in, by a cable drum, the cable; at step 412, triggering, by an electronics suite, a controlled descent of the balloon; and at step 414, deflating, by the electronics suite, the balloon.

According to an embodiment, while embodiments described herein used a T-Boon system 2 with a balloon 4, tethered drones, airships, dirigibles and the like could alternatively be used.

The disclosed embodiments provide systems and methods for improving communications in seismic acquisition operations. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims. No element, act, or instruction used in the description of the present application should be construed as critical or essential to the invention unless explicitly described as such. Also, as used herein, the article “a” is intended to include one or more items.

What is claimed is:

1. A communication system configured to be used in land geophysical operations, the system comprising:
a balloon configured to lift one or more antennas, wherein the balloon includes a tail section for keeping a front of the balloon aligned in a desired direction;
at least one cable connected to the balloon and configured for transmission of at least one of power and data, configured as a tether connected to the balloon and configured to be deployed such that an altitude of the balloon is between 50 and 100 meters, wherein a first end of the cable is connected to the balloon and a second end of the cable is connected to an object in contact with the ground;
one or more antennas mounted internally or externally to the balloon and configured to extend a communication range between a base station, a command and control truck, and one or more seismic shooting devices for communicating information associated with seismic acquisition activities;
a cable drum configured to both deploy and reel in the cable; and
an electronics suite configured to trigger a controlled descent of the balloon and configured to deflate the balloon.

2. The system of claim 1, further comprising:
the communication system configured to coordinate communications for vibrator sweep synchronization and shooting commands.

3. The system of claim 2, wherein the communication system is further configured to coordinate communications for commencing and terminating seismic recording activities.

4. The system of claim 1, further comprising:
the balloon configured to rebroadcast information associated with seismic data acquisition activities.

5. The system of claim 1, further comprising:
the communication system configured to track at least one command and control truck.

6. The system of claim 1, further comprising:
radio power amplifiers connected to the balloon.

7. The system of claim 1, further comprising:
at least one seismic sensor configured to receive at least one seismic wave.

8. A communication system configured to be used in marine seismic acquisition operations, the system comprising:
a balloon configured to lift one or more antennas, wherein the balloon includes a tail section for keeping a front of the balloon aligned in a desired direction;
at least one cable connected to the balloon and configured for transmission of at least one of power and data, configured as a tether connected to the balloon and configured to be deployed such that an altitude of the balloon is between 50 and 100 meters, wherein a first end of the cable is connected to the balloon and a second end of the cable is connected to a vessel for use in marine seismic data acquisition activities;
one or more antennas mounted internally or externally to the balloon and configured to extend a communication range between wide azimuth fleet vessels for communicating information associated with seismic acquisition activities;
a cable drum configured to both deploy and reel in the cable; and
an electronics suite configured to trigger a controlled descent of the balloon and configured to deflate the balloon.

9. The system of claim 8, further comprising:
the communication system configured to increase the range of communications between wide azimuth fleet vessels and a shore facility.

10. The system of claim 8, wherein communications performed include information associated with at least one of navigation data and shooting synchronization for the wide azimuth fleet vessels.

11. The system of claim 8, wherein the communications performed originate from a control vessel and are received by a plurality of seismic shooting vessels based on at least one of an absolute position and a relative position.

12. The system of claim 8, further comprising:
at least one seismic sensor configured to receive at least one seismic wave.

13. The system of claim 8, wherein the communication information includes received seismic signals from at least one marine seismic streamer by the one or more antennas which are then relayed from the one or more antenna to the vessel to which the balloon is tethered.

14. A system for deploying a balloon associated with a communication system configured to be usable in both land and marine seismic acquisition operations, the system comprising:
a cable drum with a cable configured to control an ascent of the balloon such that the balloon stops ascending at a height between 50-100 meters above an anchor point;
an anchoring mechanism configured to anchor a cable attached to the balloon to the anchor point;
at least one antenna configured to communicate information associated with at least one of land and marine seismic acquisition activities, wherein the information is associated with at least one of seismic shooting synchronization and seismic recording information;
the balloon with the at least one antenna configured to extend a range for communicating information associated with both land and marine seismic activities; and
an electronics suite configured to trigger a controlled descent of the balloon.

15. The system of claim 14, further comprising:
the system configured to coordinate communications for vibrator sweep synchronization when performing land geophysical activities including electromagnetic and gravity-magnetic acquisition operations.

16. The system of claim 14, further comprising:
the system configured to communicate information associated with seismic acquisition activities between wide azimuth fleet vessels when performing marine seismic activities.

17. The system of claim 14, further comprising:
the cable drum and the cable configured to control a descent of the balloon to a new altitude; and
the cable drum and the cable configured to maintain the new altitude.

18. The system of claim 17, wherein the descent of the balloon to a new altitude occurs based on received instructions.

19. The system of claim 17, wherein the descent of the balloon to a new altitude occurs when a preset condition is determined.

20. The system of claim 17, wherein land geophysical operations includes at least one of land seismic acquisition operations, electromagnetic and gravity-magnetic acquisition operations.
